(19) United States
(12) Patent Application Publication
(10) Pub. No.: US 2010/0047732 A1
(43) Pub. Date: Feb. 25, 2010

(54) APPARATUS FOR CORRECTING POSITION OF TEETH

(76) Inventor: Hyun Sang Park, Daegu (KR)

Correspondence Address: PARK LAW FIRM, 3255 WILSHIRE BLVD, SUITE 1110, LOS ANGELES, CA, 90010, US

(21) Appl. No.: 12/523,093

(22) PCT Filed: Oct. 6, 2008
(86) PCT No.: PCT/KR2008/005846

§ 371 Date: Jul. 14, 2009

(30) Foreign Application Priority Data
Nov. 8, 2007 (KR) 10-2007-0113768

(51) Int. Cl. A61C 7/00

(52) U.S. Cl. 433/18

(57) ABSTRACT

Disclosed herein is an apparatus for correcting the position of teeth used in dentistry. The apparatus for correcting the position of teeth is constructed in a structure in which an implantation unit is securely fixed to a palate, e.g., the roof of a mouth, the bony tissue of which is very excellent and the soft tissue thickness of which is small, using a fixing source, opposite suspension parts are suspended by opposite buccal molar areas to draw front teeth backward, whereby the movement of teeth at the molar tooth areas is prevented, and therefore, reimplantation is unnecessary, application points for drawing the front teeth, including the molar teeth, backward are located at the buccal molar areas, whereby the application of a force (a correction force) is easy, it is possible to induce natural extension of a dental arch (an arch-shaped area where teeth are implanted), and the teeth are moved backward to correct the irregularities of teeth, whereby it is possible to considerably reduce a possibility of tooth extraction.

### TECHNICAL FIELD

The present invention relates to an apparatus for correcting the position of teeth, and, more particularly, to an apparatus for correcting the position of teeth, including an implantation unit configured to be implanted in a palate, the bony tissue of which is very excellent and thus which serves as an absolute fixing source, opposite suspension parts configured to be suspended by opposite buccal molar areas, respectively, and hooks formed at opposite ends of the respective suspension parts such that elastic members are hooked by the corresponding hooks, and thus being capable of drawing front teeth backward, thereby achieving very efficiently the correction of the irregularities of teeth.

### BACKGROUND ART

Generally, the correction of the irregularities of teeth is achieved by fixedly attaching brackets to buccal teeth or lingual teeth, connecting a wire, such as a steel wire, to the brackets, securely implanting mini-implants (hereinafter, referred to as ‘fixing sources’) for correcting the irregularities of teeth at the roof of a mouth or an alveolar bone in the mouth, and elastic members for correction are caught by the fixing sources to move teeth.

That is, the brackets are bonded to surfaces (front surfaces or rear surfaces) of correction assistance teeth (normal teeth unnecessary to be corrected) and teeth to be corrected, the brackets are connected to one another by one or more steel wires, and the fixing sources are securely implanted in the roof of the mouth or the alveolar bone of the mouth, one end of each of the elastic members, such as coil springs, elastic rubbers, or square-shaped arcs, is connected to the steel wire at one end thereof while the other end of each of the elastic members is caught by the corresponding fixing source implanted in the alveolar bone (maxillary bone) at a position selected in consideration of a teeth correction direction and a teeth correction force such that the wire is appropriately tense, and therefore, the teeth to be corrected are moved to their normal or regular positions.

Each of the conventional fixing sources simply includes a head and a screw part like a general screw nail. The screw part is implanted in the alveolar bone, and the elastic member is caught by a neck part connected between the head and the screw part to correct the irregularities of teeth. When rotary moment is applied to the fixing sources, the fixing sources cannot resist the rotary moment (rotary force), and, in addition, the elastic members may move up and down at the neck parts of the respective fixing sources, with the result that a gum (a teethridge) may be inflamed or suffer from a complication, and therefore, time for correction may increase.

Meanwhile, when teeth (front teeth) fixed to a maxillary bone protrude forward, the fixing sources may be fastened to side alveolar bones, and the teeth may be pulled by the elastic members, whereby it is possible to easily correct the irregularities of teeth. On the other hand, when the teeth (the front teeth) fixed to the maxillary bone droop downward, the teeth may be pulled upward, whereby it is possible to easily correct the irregularities of teeth.

At this time, it may be required to draw the front teeth backward while the front teeth are moved upward; however, such adjustment is not possible only by the existing fixing sources at the molar teeth.

In a conventional method, one fixing source is implanted in one of the molar tooth sides to move the front teeth backward. In order to move the front teeth upward and backward, it is required to adjust the position at which the fixing source is implanted in the corresponding molar tooth and the hook height of the front teeth connected to the arch wire or bend the arch wire. However, such adjustment to accurately move the teeth is very difficult.

Also, in the conventional art, an operation is performed such that the head of a correction member is imbedded in the gum tissue to prevent the rotation of the correction member, with the result that pain felt by a patient due to the incision of the gum is severe, and, in addition, areas around the incised gum may be inflamed. Also, when the correction member is to be removed, after the use thereof, or is to be replaced with a new one, it is necessary to incise the gum tissue such that the head of the correction member is exposed to the outside. As a result, it takes a large amount of time for operation and recovery, and therefore, patients may suffer more severe pain.

Also, the backward movement of teeth is attempted by fixing the fixing sources in the buccal molar areas or in the oral cavity side when correcting the position of teeth. However, the bony tissue of the area where the fixing sources are mounted is poor, with the result that the use as the absolute fixing sources is not possible. Furthermore, the buccal molar areas cannot be used as the absolute fixing sources, when the buccal alveolar bone is poor or the distance between the tooth roots is small.

Also, re-implantation is required due to the movement of teeth located at the molar tooth areas. Furthermore, it is not possible to wholly move the teeth according to the conventional structure and method. Consequently, it is difficult to establish application points for drawing the teeth backward. In addition, the application of a force is difficult. Besides, the extension of a dental arch is difficult, and a possibility of tooth extraction increases.

That is, when the mini-implants are implanted in the buccal molar areas, with the result that re-implantation is frequently required due to the movement of teeth located at the molar teeth. Consequently, time for correction increases, and, in addition, the reimplantation is necessary. Furthermore, it is not possible to simultaneously move the front teeth, including the molar teeth, backward.

### DISCLOSURE OF INVENTION

### Technical Problem

It is an object of the present invention to provide an apparatus for correcting the position of teeth that can be implanted in a palate having excellent bony tissue and suspended by opposite buccal molar areas, wherein the apparatus for correcting the position of teeth is very excellently used as an absolute fixing source for correcting the irregularities of teeth, and application points for drawing front teeth backward are located at the buccal molar areas in the structural aspect of the apparatus for correcting the position of teeth, whereby the application of a force is easy.

It is another object of the present invention to provide implantation units and hooks configured in various structures.

### Technical Solution

In accordance with the present invention, the above and other objects can be accomplished by the provision of an apparatus for correcting the position of teeth constructed in a structure in which an implantation unit is securely implanted in a palate, e.g., the roof of a mouth, the bony tissue of which is very excellent and thus which serves as an absolute fixing source, opposite suspension parts are suspended by opposite buccal molar areas to draw front teeth backward, whereby the movement of teeth at the molar tooth areas is prevented, and therefore, re-implantation is unnecessary, application points for drawing the front teeth, including the molar teeth, backward are located at the buccal molar areas, whereby the application of a correction force is easy, it is possible to induce natural extension of a dental arch, the teeth are moved, using the backward drawing force, whereby it is possible to considerably reduce a possibility of tooth extraction, and the apparatus for correcting the position of teeth has an excellent applicability through the provision of implantation units and hooks configured in various structures.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a bottom perspective view illustrating an apparatus for correcting the position of teeth according to an embodiment of the present invention;

FIG. 2 is a plan view illustrating the apparatus for correcting the position of teeth according to the an embodiment of the present invention;

FIG. 3 is a bottom view illustrating the apparatus for correcting the position of teeth according to the an embodiment of the present invention;

FIG. 4 is a front view illustrating the apparatus for correcting the position of teeth according to the an embodiment of the present invention;

FIG. 5 is a sectional view taken along line A-A′ of FIG. 2;

FIG. 6 is a side view illustrating the apparatus for correcting the position of teeth according to the an embodiment of the present invention;

FIG. 7 is an enlarged sectional view taken along line B-B′ of FIG. 1;

FIGS. 8A to 8I are constructional views illustrating implantation units according to various embodiments of the present invention;

FIGS. 9A to 9F are partial constructional views illustrating hooks according to various embodiments of the present invention;

FIG. 10 is a bottom perspective view illustrating an apparatus for correcting the position of teeth according to another embodiment of the present invention;

FIGS. 11A to 11F are side views and side sectional views illustrating implantation units according to various embodiments of the present invention;

FIG. 12 is a bottom view illustrating the use state of the apparatus for correcting the position of teeth according to the present invention;

FIG. 13 is a sectional view illustrating the use state of the apparatus for correcting the position of teeth according to the present invention;

FIG. 14 is a side view illustrating the use state of the apparatus for correcting the position of teeth according to the present invention;

FIG. 15 is a side view illustrating the correction of irregularities of teeth performed by the apparatus for correcting the position of teeth according to the present invention.

### BEST MODE FOR CARRYING OUT THE INVENTION

Now, preferred embodiments of the present invention will be described in detail with reference to the annexed drawings. In the drawings, the same or similar elements are denoted by the same reference numerals even though they are depicted in different drawings. In the following, a detailed description of known functions and configurations incorporated herein will be omitted when it may make the subject matter of the present invention rather unclear.

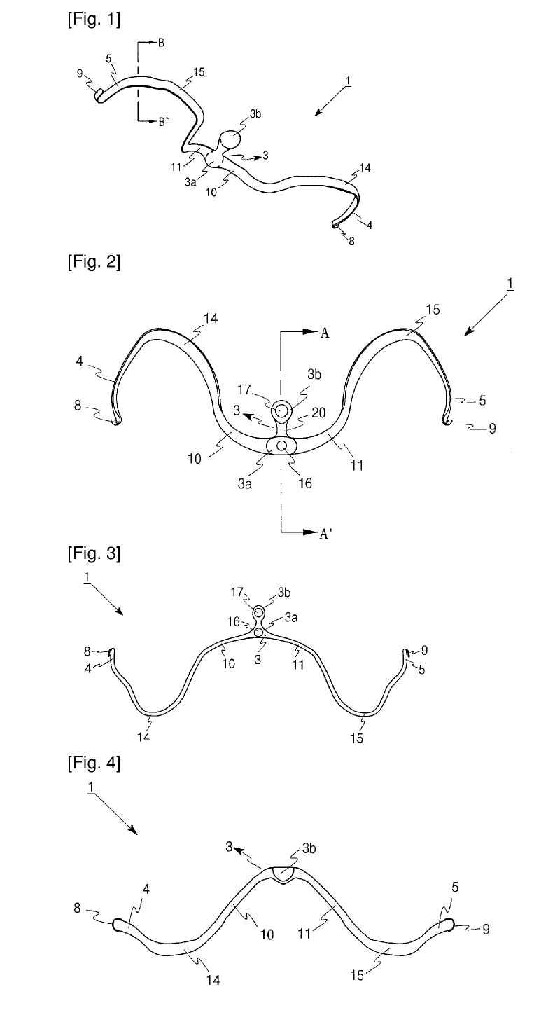

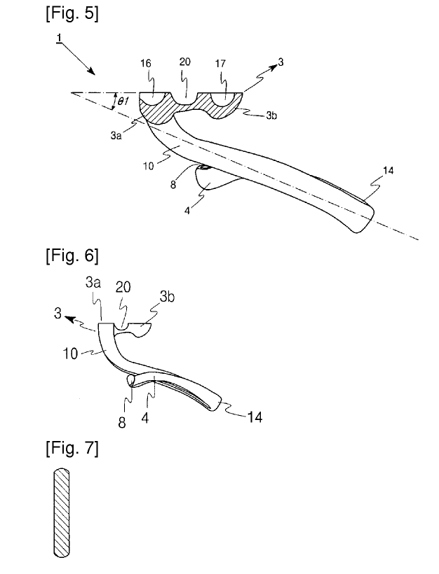

An apparatus 1 for correcting the position of teeth according to the present invention is an apparatus that is used to achieve the backward movement of teeth when principally correcting the irregularities of teeth at the maxillary bone or is applicable when requiring an absolute fixing source at a rear region. FIG. 1 is a bottom perspective view illustrating an apparatus 1 for correcting the position of teeth according to an embodiment of the present invention, FIG. 2 is a plan view illustrating the apparatus 1 for correcting the position of teeth, FIG. 3 is a bottom view illustrating the apparatus 1 for correcting the position of teeth, FIG. 4 is a front view illustrating the apparatus 1 for correcting the position of teeth, FIG. 5 is a sectional view taken along line A-A′ of FIG. 2, and FIG. 12 is a bottom view illustrating the use state of the apparatus 1 for correcting the position of teeth.

The apparatus 1 for correcting the position of teeth according to the present invention is constructed in a structure in which an implantation unit 3 is formed at the central part of the apparatus 1 such that the implantation unit 3 is implanted in a palate 2 to securely fix the apparatus 1, hooks 8 and 9 are formed at opposite ends 4 and 5 of the implantation unit 3 such that elastic members 7, such as coil springs, elastic rubbers, or square-shaped arcs, to draw teeth 6 backward are hooked by the hooks 8 and 9, and a pair of suspension parts 14 and 15 are connected between the hooks 8 and 9 and corresponding connection parts 10 and 11, respectively, such that the suspension parts 14 and 15 are suspended by gums protruding from the rear of first and second molar teeth (grinding teeth) or third molar teeth (wisdom teeth), e.g., maxillary gums 12 and 13, respectively. Consequently, the apparatus 1 for correcting the position of teeth according to the present invention is configured approximately in the shape of W.

In the implantation unit 3 are formed two or more coupling grooves 16 and 17 in a depressed fashion such that the coupling grooves 16 and 17 are arranged either before and behind or from side to side. In the coupling grooves 16 and 17 are coupled heads of fixing sources 18 and 19 implanted in the palate 2 such that the heads of the fixing sources 18 and 19 protrude into the mouth, respectively. The implantation unit 3 is securely joined to the fixing sources 18 and 19 by joining the heads of fixing sources 18 and 19 to the corresponding coupling grooves 16 and 17 using an adhesive, such as resin, used in dentistry. The fixing sources 18 and 19 are implanted in the palate 2. Consequently, the apparatus 1 for correcting the position of teeth is securely fixed, and the opposite suspension parts 14 and 15 are suspended by the gums 12 and 13, respectively, thereby preventing the movement of the apparatus 1 for correcting the position of teeth. The fixing sources 18 and 19 and the implantation unit 3, joined to each other by the resin, may be separated from each other by cutting or melting the resin.

The apparatus 1 for correcting the position of teeth is made of metal or synthetic resin which is harmless to humans, and is configured in a single body. As shown in FIG. 7, most of the apparatus 1 for correcting the position of teeth, including the suspension parts 14 and 15, has a small thickness and a large height and width, by which the apparatus 1 for correcting the position of teeth does not apply a large amount of pressure to the gums 12 and 13. Furthermore, the edge of the apparatus 1 for correcting the position of teeth is formed in a curved shape or is ground into a curved shape.

The number of the coupling grooves 16 and 17, formed in the implantation unit 3, is several not one, and the coupling grooves 16 and 17 are spaced a predetermined distance from each other. Consequently, it is possible to prevent the occurrence of the rotary moment of the implantation unit 3 due to the unbalance of a correction force or an unnecessary external force.

The implantation unit 3 may include a protrusion 3b extending forward from the coupling groove 16, located at the central part, as shown in FIGS. 3 and 12, or a protrusion 3b extending backward from the coupling groove 16, as shown in FIGS. 1 and 2. The coupling groove 17 is formed in the protrusion 3b. The coupling grooves 16 and 17 are depressed while being open upward such that the coupling grooves 16 and 17 can be easily coupled to the fixing sources 18 and 19 implanted in the palate 2, respectively.

The extension direction of the protrusion 3b is appropriately decided in consideration of the position of the fixing sources 18 and 19 implanted in the palate 2. Consequently, it is possible to use the apparatus 1 for correcting the position of teeth including the protrusion 3b which extends in a desired direction.

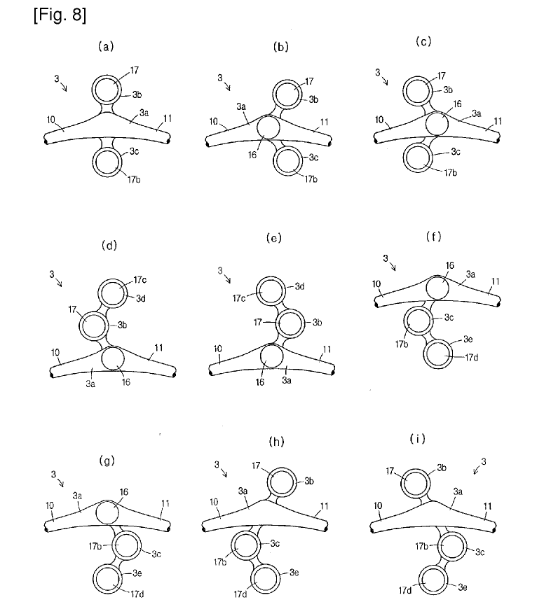

FIGS. 8A to 8I are constructional views illustrating various embodiments of protrusions formed at the implantation unit 3.

FIG. 8A illustrates protrusions 3b and 3c formed at the top and bottom of the central part 3a, respectively. Coupling grooves 17 and 17b are formed in the protrusions 3b and 3c, respectively. FIG. 8B illustrates protrusions 3b and 3c formed at the top and bottom of the central part 3a, respectively, while the protrusions 3b and 3c are inclined toward one side. In the same manner, coupling grooves 17 and 17b are formed in the protrusions 3b and 3c, respectively. FIG. 8C illustrates protrusions 3b and 3c formed at the top and bottom of the central part 3a, respectively, while the protrusions 3b and 3c are inclined toward the other side. In the same manner, coupling grooves 17 and 17b are formed in the protrusions 3b and 3c, respectively. FIG. 8D illustrates a protrusion 3b formed at the top of the central part 3a while the protrusion 3b is inclined toward the other side and a protrusion 3d formed at the top of the protrusion 3b while the protrusion 3d is inclined toward one side. Coupling grooves 17 and 17c are formed in the protrusions 3b and 3d, respectively. FIG. 8E illustrates a protrusion 3b formed at the top of the central part 3a while the protrusion 3b is inclined toward one side and a protrusion 3d formed at the top of the protrusion 3b while the protrusion 3d is inclined toward the other side. In the same manner, coupling grooves 17 and 17c are formed in the protrusions 3b and 3d, respectively. FIG. 8F illustrates a protrusion 3c formed at the bottom of the central part 3a while the protrusion 3c is inclined toward the other side and a protrusion 3e formed at the bottom of the protrusion 3c while the protrusion 3e is inclined toward one side. Coupling grooves 17b and 17d are formed in the protrusions 3c and 3e, respectively. FIG. 8G illustrates a protrusion 3c formed at the bottom of the central part 3a while the protrusion 3c is inclined toward one side and a protrusion 3e formed at the bottom of the protrusion 3c while the protrusion 3e is inclined toward the other side. In the same manner, coupling grooves 17b and 17d are formed in the protrusions 3c and 3e, respectively. FIG. 8H illustrates a protrusion 3b formed at the top of the central part 3a while the protrusion 3b is inclined toward one side, a protrusion 3c formed at the bottom of the central part 3a while the protrusion 3c is inclined toward the other side, and a protrusion 3e formed at the bottom of the protrusion 3c while the protrusion 3e is inclined toward one side. Coupling grooves 17, 17b and 17d are formed in the protrusions 3b, 3c and 3e, respectively. FIG. 8I illustrates a protrusion 3b formed at the top of the central part 3a while the protrusion 3b is inclined toward the other side, a protrusion 3c formed at the bottom of the central part 3a while the protrusion 3c is inclined toward one side, and a protrusion 3e formed at the bottom of the protrusion 3c while the protrusion 3e is inclined toward the other side. In the same manner, coupling grooves 17, 17b and 17d are formed in the protrusions 3b, 3c and 3e, respectively.

The extension directions of the protrusions 3b, 3d, and 3e are appropriately decided in consideration of the position of the fixing sources 18 and 19 implanted in the palate 2. Consequently, it is possible to use an apparatus 1a for correcting the position of teeth including the protrusions 3b, 3d, and 3e which extend in desired directions.

In the present invention, the suspension parts 14 and 15 are formed in the same shapes as the gums 12 and 13 or in curved shapes similar to those of the gums 12 and 13 such that the suspension parts 14 and 15 can surround the gums 12 and 13, respectively. There are height differences between the gums 12 and 13 and the palate 2. According to the present invention, therefore, the suspension parts 14 and 15 have an inclination 1 of approximately 10 to 20 degrees to the implantation unit 3, as shown in FIG. 5. Also, the opposite ends 4 and 5 have an inclination 2 of approximately 100 to 170 degrees to the suspension parts 14 and 15, by which it is possible to sufficiently draw the teeth 6a to be corrected upward/backward, as shown in FIGS. 14 and 15. The inclinations 1 and 2 may be adjusted to have appropriate inclination values 1, 2, and 3 according to the position or the correction angle of the teeth 6a.

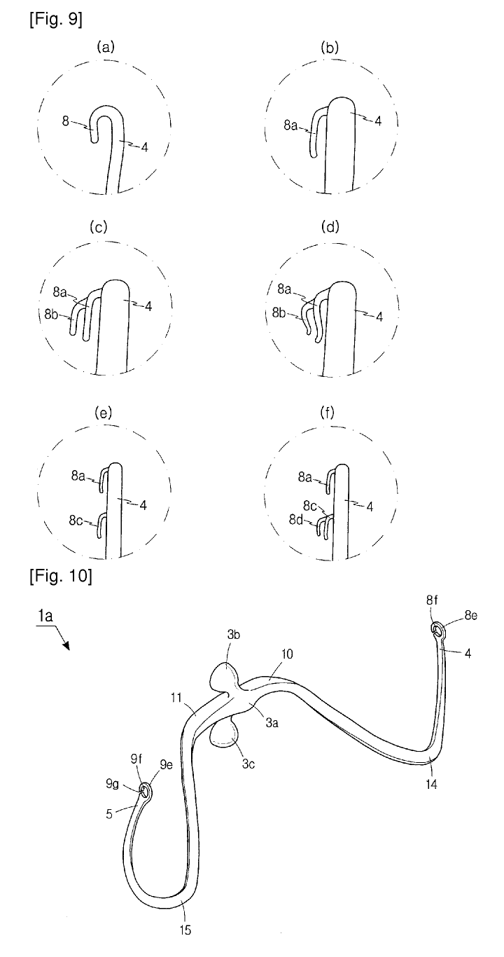

FIGS. 9A to 9F are partial constructional views illustrating various embodiments of the hooks 8 formed at the opposite ends 4 and 5 of the apparatus 1 for correcting the position of teeth such that the corresponding elastic members 7 are hooked by the hooks 8. The hooks 8 are opened in the direction opposite to the direction in which the corresponding elastic members 7 are hooked. Furthermore, the hooks 8 extend backward such that the hooked state of the corresponding elastic members 7 can be maintained even when the corresponding elastic members 7 are moved by external pressure.

FIG. 9A illustrates a hook 8 formed by bending outward the end 4 of the apparatus 1 for correcting the position of teeth. FIG. 9B illustrates a hook 8a, having a predetermined length and a predetermined width (or a predetermined height), fixed to the outside of the end 4 of the apparatus 1 for correcting the position of teeth by welding.

FIGS. 9C and 9D illustrate another hook 8b formed at the outside of the hook 8a such that a plurality of elastic members 7 can be hooked by the hooks 8a and 8b when a plurality of teeth are needed to be corrected or a complex correction force is required. In FIG. 9C, the hooks 8a and 8b are formed such that the elastic members 7 can be easily hooked by the hooks 8a and 8b. In FIG. 9D, the hooks 8a and 8b are formed such that the rear ends of the hooks 8a and 8b are adjacent to the outside of the end 4 of the apparatus 1 for correcting the position of teeth, whereby it is difficult for the elastic members 7 to be separated from the hooks 8a and 8b.

FIG. 9E illustrates another hook 8c formed at the rear of the end 4 at which the hook 8a is formed such that the hooks 8a and 8c are spaced a predetermined distance from each other at the outside of the end 4 of the apparatus 1 for correcting the position of teeth. FIG. 9F illustrates another hook 8d formed at the outside of the hook 8c located at the rear of the end 4 such that the hooks 8c and 8d lie one on top of another. The construction of FIG. 9F is appropriately used when a complex correction force is required.

Although FIGS. 9A to 9F illustrate that the hooks 8, 8a, 8b, 8c, and 8d are formed such that the two hooks lie one on top of the other or are spaced a predetermined distance from each other, three or more hooks may be disposed in an overlapping fashion or arranged side by side in a line.

As shown in FIGS. 9A to 9F, the hooks 8, 8a, 8b, 8c, and 8d are formed on one end 4 of the apparatus 1 for correcting the position of teeth. Of course, the hooks 8, 8a, 8b, 8c, and 8d are formed on the other end 5 of the apparatus 1 for correcting the position of teeth in a symmetrical fashion.

FIG. 10 is a bottom perspective view illustrating an apparatus 1a for correcting the position of teeth according to another embodiment of the present invention. The apparatus 1a for correcting the position of teeth is constructed in a structure in which protrusions 3b and 3c are formed at the top and bottom of a central part 3a of an implantation unit, round hooks 8e and 9e including insertion slits 8g and 9g and hooking holes 8f and 9f are formed at opposite ends 4 and 5 of the implantation unit, respectively, such that elastic members 7 are inserted through the insertion slits 8g and 9g and are hooked in the hooking holes 8f and 9f.

The insertion slits 8g and 9g are formed at the rear of the corresponding hooks 8e and 9e where it is easy to insert the elastic members 7 into the hooks 8e and 9e but it is difficult to separate the elastic members 7 from the hooks 8e and 9e, e.g., in the direction opposite to a pulling force applied to the elastic members 7.

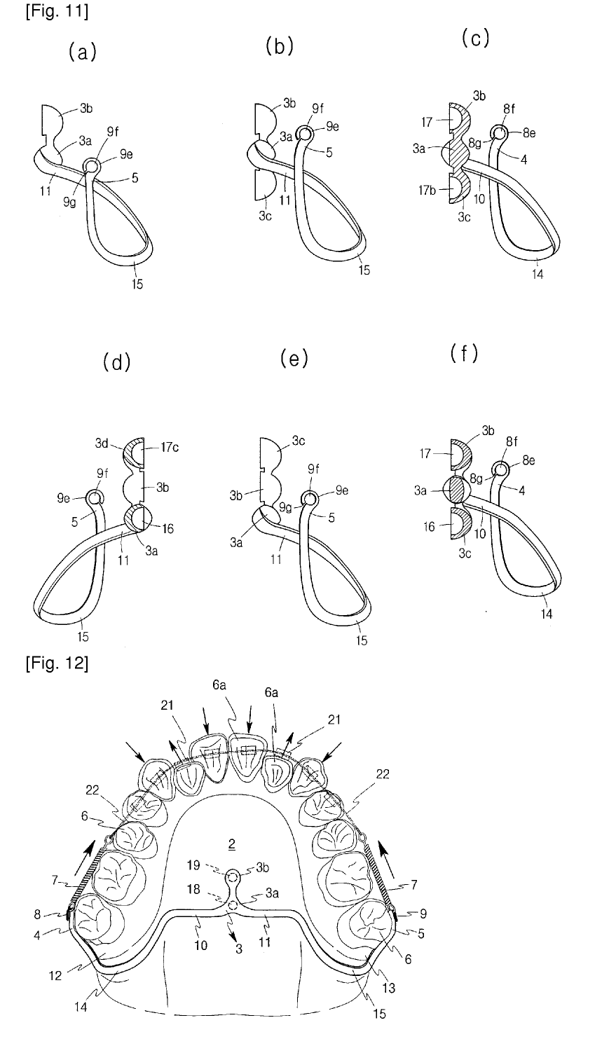

FIGS. 11A to 11F are side views and side sectional views of the implantation unit 3. FIG. 11A is a side view of FIG. 10, FIG. 11B is a side view of FIG. 8B or 8C, FIG. 11C is a sectional view of the central part 3a shown in FIG. 8A, FIG. 11D is a sectional view of FIG. 8E, FIG. 11E is a side view of FIG. 8D or 8E, and FIG. 11F is a sectional view of FIG. 8B or 8C.

In a conventional apparatus for correcting the position of teeth, fixing sources, e.g., mini-implants, are implanted in the buccal molar areas, with the result that reimplantation may be required due to the movement of teeth located at the molar teeth. On the other hand, the apparatus 1 or 1a for correcting the position of teeth according to the present invention is implanted in the palate, the bony tissue of which is very excellent as compared with other regions and thus which serves as an absolute fixing source, with the result that the movement of teeth at the molar tooth areas is prevented, and therefore, re-implantation is unnecessary. Also, it is possible to simultaneously move the front teeth, including the molar teeth, backward, thereby achieving very efficiently the correction of the irregularities of teeth.

Also, application points for drawing the front teeth backward are located at the buccal molar areas in the structural aspect of the present invention. Consequently, the application of a force is easy. Furthermore, the backward drawing force at the buccal molar areas reduces the frequency of tooth extraction during the correction of the irregularities of teeth.

Also, the present invention induces natural extension of a dental arch. Furthermore, the teeth are moved, using the backward drawing force, to correct the irregularities of teeth, and therefore, it is possible to considerably reduce a possibility of tooth extraction.

The central part 3a of the apparatus 1 or 1a for correcting the position of teeth according to the present invention is coupled to the fixing sources 18 and 19 fastened to the maxillary bone such that the central part 3a is maintained as the fixing point, and the opposite suspension parts 14 and 15 of the apparatus 1 for correcting the position of teeth are suspended by the buccal molar areas, e.g., the gums 12 and 13.

The apparatus 1 for correcting the position of teeth according to the present invention may be standardized such that the apparatus 1 for correcting the position of teeth has an appropriate size in consideration of the mouth sizes or teeth correction conditions of persons whose teeth are to be corrected, whereby it is possible to mass-produce the apparatus 1 for correcting the position of teeth.

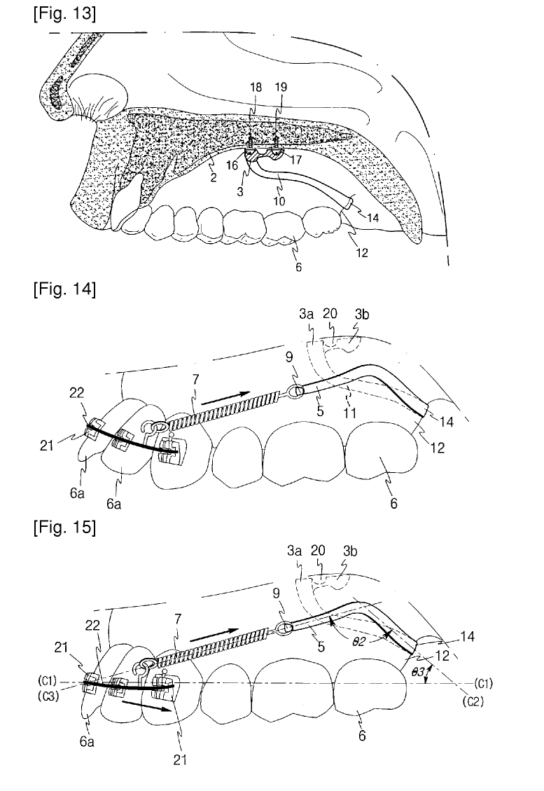

When studying the action of a force in the present invention, the implantation unit 3 is coupled and fixed to the fixing sources 18 and 19, which are fastened to the maxillary bone (the palate), as shown in FIGS. 12 and 13, with the result that the fixing point is maintained. Also, the suspension parts 14 and 15, which are suspended by the corresponding gums 12 and 13 by a drawing force of the elastic members 7, which are hooked by the hooks 8 and 9, and a wire 22 connected between the elastic members 7, provide a support force in the direction opposite to the direction in which the drawing force is applied. As a result, the implantation unit 3 is securely and absolutely fixed to the palate 2.

In the present invention, the opposite suspension parts 14 and 15 are located at the molar tooth areas or the wisdom tooth areas, the implantation unit 3, which is positioned at the middle of the apparatus for correcting the position of teeth, is fixed to the heads of the fixing sources 18 and 19, which are implanted in the palate area, and the elastic members 7, which are connected to each other by the correction wire 22, are hooked by the hooks 8 and 9, which protrude outward, such that the total teeth or the teeth to be corrected are drawn backward, whereby a more secure and efficiency support force is maintained, and time for correction is greatly reduced.

Also, in the present invention, a major portion of the apparatus 1 or 1a for correcting the position of teeth is located at the buccal molar areas, i.e., the gums 12 and 13, and the palate area. Consequently, a foreign body sensation felt by patients using the apparatus 1 or 1a for correcting the position of teeth decreases.

In FIG. 15, lines C1, C2, and C3 are imaginary lines drawn to explain the inclinations 2 and 3.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As apparent from the above description, the apparatus for correcting the position according to the present invention is implanted in the palate, the bony tissue of which is very excellent and thus which serves as an absolute fixing source, and the opposite suspension parts are suspended by the buccal molar areas such that the front teeth can be drawn backward. Consequently, the present invention has the effect of providing a very excellent correction force. Also, application points for drawing the front teeth backward are located at the buccal molar areas in the structural aspect of the present invention. Consequently, the present invention has the effect of achieving easy application of a force. Furthermore, the present invention has the effect of preventing the movement of teeth at the molar tooth areas and thus not requiring re-implantation. In addition, the present invention has the effect of simultaneously drawing the front teeth, including the molar teeth, backward.

In the conventional apparatus for correcting the position, the buccal molar areas cannot be used as the absolute fixing sources, when the buccal alveolar bone is poor or the distance between the tooth roots is small. However, the apparatus for correcting the position according to the present invention can be used without restriction.

Also, in the apparatus for correcting the position according to the present invention, the palate area is used as the absolute fixing source, and therefore, the backward drawing force at the buccal molar areas considerably reduces the frequency of tooth extraction during the correction of the irregularities of teeth. Furthermore, the present invention induces natural extension of the dental arch. In addition, the teeth are moved backward, and therefore, it is possible to considerably reduce a possibility of tooth extraction. Consequently, the present invention is very useful.

What is claimed is:

1. An apparatus for correcting the position of teeth, comprising:
an implantation unit having coupling grooves formed at a central part and at least one protrusion thereof;
hooks formed at opposite ends of the implantation unit such that elastic members are hooked by the corresponding hooks; and
a pair of left and right suspension parts formed between the hooks and connection parts such that the suspension parts are suspended by buccal molar areas.

2. The apparatus according to claim 1, wherein the implantation unit, the hooks, and the suspension parts are connected to one another in the shape of W.

3. The apparatus according to claim 1, further comprising:
additional hooks (8b) formed at the outsides of the respective hooks.

4. The apparatus according to claim 1, further comprising:
additional hooks (8c) formed at rears of the opposite ends at which the hooks are formed such that the additional hooks are spaced apart from the corresponding hooks.

5. The apparatus according to claim 1, wherein the suspension parts have an inclination (1) of 10 to 20 degrees to the implantation unit, and the opposite ends have an inclination (2) of 100 to 170 degrees to the corresponding suspension parts.

6. The apparatus according to claim 1, wherein the at least one protrusion of the implantation unit includes a plurality of protrusions.

7. The apparatus according to claim 1, wherein each of the hooks is a round hook having an insertion slit and a hooking hole.

8. The apparatus according to claim 2, further comprising:
additional hooks (8b) formed at the outsides of the respective hooks.

9. The apparatus according to claim 2, further comprising:
additional hooks (8c) formed at rears of the opposite ends at which the hooks are formed such that the additional hooks are spaced apart from the corresponding hooks.

10. The apparatus according to claim 2, wherein the suspension parts have an inclination (1) of 10 to 20 degrees to the implantation unit, and the opposite ends have an inclination (2) of 100 to 170 degrees to the corresponding suspension parts.

11. The apparatus according to claim 2, wherein the at least one protrusion of the implantation unit includes a plurality of protrusions.
